(19) United States
(12) Patent Application Publication
(10) Pub. No.: US 2026/0210411 A1
(43) Pub. Date: Jul. 23, 2026

(54) DRIVE APPARATUS FOR VEHICLE

(71) Applicant: TOYOTA JIDOSHA KABUSHIKI KAISHA, Toyota-shi (JP)

(72) Inventors: Naoto ONODA, Mishima-shi (JP); Masato FUJIKAWA, Susono-shi (JP); Takahito ENDO, Sunto-gun (JP)

(73) Assignee: TOYOTA JIDOSHA KABUSHIKI KAISHA, Toyota-shi (JP)

(21) Appl. No.: 19/411,519

(22) Filed: Dec. 8, 2025

(30) Foreign Application Priority Data
Jan. 23, 2025 (JP) 2025-010181

(51) Int. Cl. F16D 9/08; B60K 1/00; B60K 17/24

(52) U.S. Cl. CPC F16D 9/08; B60K 17/24; B60K 1/00; B60K 2001/001

(57) ABSTRACT

A vehicle drive apparatus includes: a drive unit; a final speed reducer for distributing a power of the drive unit, to drive wheels; and a transmission shaft through which the power is to be transmitted to the final speed reducer. The transmission shaft includes: an intermediate shaft; a first joint connecting between the intermediate shaft and the drive unit; and a second joint connecting between the intermediate shaft and the final speed reducer. The second joint includes: a second outer race; and a second connection shaft which extends from the second outer race and which is connected to the final speed reducer. The transmission shaft includes a most vulnerable portion having a strength smaller than any other portion of the transmission shaft. The most vulnerable portion is located between the second outer race and a connected portion at which the second connection shaft is connected to the final speed reducer.

This application claims priority from Japanese Patent Application No. 2025-010181 filed on Jan. 23, 2025, the disclosure of which is herein incorporated by reference in its entirety.

### FIELD OF THE INVENTION

The present invention relates to a drive apparatus for a vehicle, and more specifically, to a technique for preventing run-out rotation of a transmission shaft in event of breakage of the transmission shaft, which is provided to transmit a power of a drive unit to a final speed reducer.

### BACKGROUND OF THE INVENTION

There is known a transmission shaft for a vehicle, through which a power of a drive unit provided in a vehicle body (above suspension springs) is to be transmitted to a final speed reducer housed in an axle tube, i.e., axle housing (below the suspension springs). The transmission shaft is connected to the drive unit at an end portion through a first joint, and to the final speed reducer at another end portion through a second joint. Thus, in spite of relative displacement between the drive unit and the final speed reducer caused by deformation of the suspension springs during running of the vehicle, or relative vertical displacement between the vehicle body (above the suspension springs) and the axle housing (below the suspension springs), the power outputted from the drive unit is reliably transmitted to the final speed reducer owing to rotational articulation functions of the first and second joints. For example, JP H09-240296 A discloses a drive apparatus for an electric vehicle, which includes such a transmission shaft.

### SUMMARY OF THE INVENTION

However, as compared to the other power transmission components in the vehicle, the transmission shaft has more stringent requirements regarding allowable strength and dimensions. Therefore, when transmitting the power required to meet vehicle's performance requirements, the transmission shaft could become the most vulnerable component in the power transmission system. In particular, an intermediate shaft, which is the longest component of the transmission shaft, could be the most vulnerable part. Consequently, if the intermediate shaft is broken, the broken intermediate shaft, which is exposed below a floor of the vehicle, could suffer from run-out rotation during running of the vehicle, thereby causing a risk of secondary damage of other components located near the intermediate shaft.

The present invention was made in view of the background art described above. It is therefore an object of the present invention to provide a drive apparatus for a vehicle, which is capable of effectively preventing damage of the intermediate shaft that is the longest component of the transmission shaft.

The object indicated above is achieved according to the following aspects of the present invention.

According to a first aspect of the invention, there is provided a drive apparatus for a vehicle that includes a vehicle body and drive wheels. The drive apparatus includes: (a) a drive unit provided in the vehicle body; (b) a final speed reducer configured to distribute a power of the drive unit, to the drive wheels; (c) an axle housing which houses the final speed reducer and which supports the vehicle body through suspension springs; and (d) a transmission shaft through which the power of the drive unit is to be transmitted to the final speed reducer. The transmission shaft includes (d-1) an intermediate shaft, (d-2) a first joint connecting between the intermediate shaft and the drive unit and (d-3) a second joint connecting between the intermediate shaft and the final speed reducer. The first joint includes (d-2-1) a first outer race and (d-2-2) a first connection shaft which extends from the first outer race and which is connected to the drive unit. The second joint includes (d-3-1) a second outer race and (d-3-2) a second connection shaft which extends from the second outer race and which is connected to the final speed reducer. The transmission shaft includes a most vulnerable portion having a strength smaller than any other portion of the transmission shaft, such that the most vulnerable portion is located between the second outer race and a connected portion at which the second connection shaft is connected to the final speed reducer.

In the drive apparatus according to the first aspect of the invention, the transmission shaft includes the intermediate shaft, the first joint connecting between the intermediate shaft and the drive unit and the second joint connecting between the intermediate shaft and the final speed reducer. The first joint includes the first outer race and the first connection shaft which extends from the first outer race and which is connected to the drive unit. The second joint includes the second outer race and the second connection shaft which extends from the second outer race and which is connected to the final speed reducer. The transmission shaft includes the most vulnerable portion having the strength smaller than any other portion of the transmission shaft, such that the most vulnerable portion is located between the second outer race and the connected portion at which the second connection shaft is connected to the final speed reducer. Thus, in case that a high load is applied to the transmission shaft, the most vulnerable portion, which is located between the second outer race and the connected portion (at which the second connection shaft is connected to the final speed reducer) and which has the strength smaller than any other portion of the transmission shaft, would be broken first, thereby preventing damage to the intermediate shaft exposed below a floor of the vehicle. Thus, it is possible to prevent a secondary damage to other components surrounding the intermediate shaft, which could occur if the intermediate shaft suffers from run-out rotation during running of the vehicle.

According to a second aspect of the invention, in the drive apparatus according to the first aspect of the invention, there is further provided a separation prevention device configured, in event of breakage of the most vulnerable portion, to prevent an intermediate-shaft-side portion of the second connection shaft from being separated from the final speed reducer, irrespective of an axial displacement of the transmission shaft by a maximum displaceable distance, wherein the intermediate-shaft-side portion of the second connection shaft is located between the most vulnerable portion and the second outer race. Owing to the separation prevention device, in event of breakage of the most vulnerable portion, the intermediate-shaft-side portion of the second connection shaft can be prevented from being separated from the final speed reducer.

### BRIEF DESCRIPTION OF THE DRAWINGS

FIG. 1 is a view schematically showing a construction of a drive apparatus for a rigid-axle-type electric vehicle, which includes a suspension device according to an embodiment of the present invention;

FIG. 2 is a view for explaining a construction of a transmission shaft shown in FIG. 1;

FIG. 3 is a view schematically showing a construction of a most vulnerable portion of the transmission shaft shown in FIG. 2 and a construction of a separation prevention device;

FIG. 4 is a view schematically showing a construction of a most vulnerable portion of the transmission shaft and a construction of a separation prevention device in second embodiment of the invention;

FIG. 5 is a view schematically showing a construction of a most vulnerable portion of the transmission shaft and a construction of a separation prevention device in third embodiment of the invention; and

FIG. 6 is a view schematically showing a construction of a most vulnerable portion of the transmission shaft and a construction of a separation prevention device in fourth embodiment of the invention.

### DETAILED DESCRIPTION OF PREFERRED EMBODIMENTS

Hereinafter, embodiments of the invention will be described in detail with reference to the accompanying drawings. It is noted that figures of the drawings are simplified or deformed as needed, and each portion is not necessarily precisely depicted in terms of dimension ratio, shape, etc.

### First Embodiment

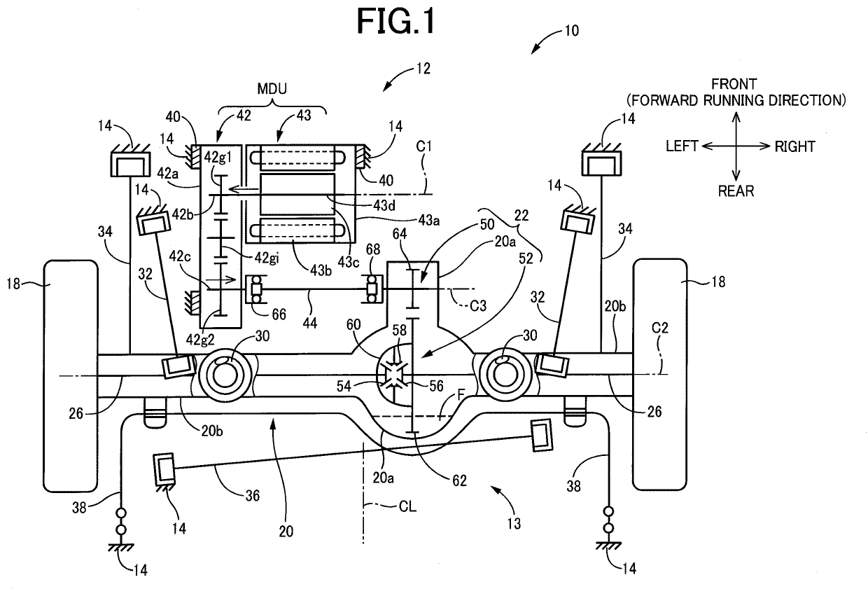

FIG. 1 is a view schematically showing a construction a drive apparatus 12 for a rigid-axle-type electric vehicle 10. The electric vehicle 10 is a rigid-type vehicle, including a suspension device 13 that supports a vehicle body 14, allowing the vehicle body 14 to be moved vertically, and an axle housing (i.e., axle tube) 20 that is interposed between right and left drive wheels 18 as front or rear wheels. The vehicle body 14 constitutes a component above suspension springs, while the axle housing 20 constitutes a component below the suspension springs. The axle housing 20 houses a final speed reducer 22 and a pair of drive shafts 26.

The suspension system 13 is a well-known 5-link type, including coil springs (suspension springs) 30, a pair of right and left upper trailing arms 32, a pair of right and left lower trailing arms 34 and a lateral rod 36, which are provided between the vehicle body 14 and the axle housing 20. The lateral rod 36 is connected at one of its opposite end portions to the vehicle body 14 and at the other of the opposite end portions to the axle housing 20, thereby restricting lateral displacement of the axle housing 20. The axle housing 20 is held in its longitudinal and lateral positions by the pair of upper trailing arms 32, the pair of lower trailing arms 34 and the lateral rod 36. Further, the axle housing 20 is pivotably connected at the opposite end portions to two intermediate portions of a stabilizer bar link 38 that is connected at its opposite end portions to the vehicle body 14. The stabilizer bar link 38 restricts a roll (lateral tilt) of the vehicle body 14.

The drive apparatus 12 includes: a speed reducer 42 having a gearbox 42a supported by the vehicle body 14 through a mount 40; an electric motor 43 located above the suspension springs, connected to the speed reducer 42 and supported by the vehicle body 14 through the mount 40; a transmission shaft 44 through which the drive force from the speed reducer 42 to the final speed reducer 22 located below the suspension springs; the final speed reducer 22 configured to receive the drive force and distribute the drive force to the right and left drive wheels 18 while allowing differential rotations of the right and left drive wheels 18; and the pair of drive shafts 26 configured to transmit output of the final speed reducer 22 to the right and left drive wheels 18, which are rotatably mounted in opposite end portions of the axle housing 20. The speed reducer 42 and the electric motor 43 constitute an electric drive unit MDU supported on the vehicle body 14.

The electric motor 43 serves as a drive power source of the electric vehicle 10, and is, for example, an AC synchronous electric motor. Preferably, the electric motor 43 is a so-called motor-generator, serving as both an electric motor and an electric generator. The electric motor 43 is supported by the vehicle body 14 through the mount 40, and includes a motor casing 43a fixed adjacent to the gear box 42a, a cylindrical stator 43b fixed within the motor casing 43a, a rotor 43c disposed inside the stator 43b, and a rotor shaft 43d which supports the rotor 43c and which is rotatably disposed in the motor casing 43a. A rotation axis C1 of the rotor shaft 43d extends in a lateral direction of the electric vehicle 10, so that the electric motor 43 is disposed horizontally.

The speed reducer 42 includes the gear box 42a, an input shaft 42b extending from the gear box 42a and concentrically connected to the rotor shaft 43d of the electric motor 43, and an output shaft 42c extending from the gear box 42a towards the electric motor 43, in parallel to the input shaft 42b. An input gear 42g1 fixed to the input shaft 42b and an output gear 42g2 (larger in diameter than the input gear 42g1) fixed to the output shaft 42c mesh with each other through an idler gear 42gi. The speed reducer 42 configured to output the power of the electric motor 43 from the output shaft 42c, while reducing the rotational speed. The input shaft 42b of the speed reducer 42 extends towards the electric motor 43, and is connected to the electric motor 43. The output shaft 42c of the speed reducer 42 extends towards the electric motor 43, and is connected to one of opposite end portions of the transmission shaft 44 on a side of the vehicle body 14. The transmission shaft 44 extends in a width direction of the electric vehicle 10. Thus, the speed reducer 42 transmits the power of the electric motor 43 to the transmission shaft 44 that is located on the same side (i.e., right side) as the electric motor 43 relative to the speed reducer 42. That is, the speed reducer 42 makes a U-turn in transmission of the power, thereby enabling the electric vehicle 10 to be built compact not only in its longitudinal direction but also in its lateral direction.

The final speed reducer 22 is located on right side of a center line CL, namely, on a side remote from the electric drive unit MDU in a width direction of the vehicle body 14, i.e., in right-left direction in FIG. 1. As a result, a space on left side of the center line C, i.e., a side closer to the electric drive unit MDU, is made larger than a space on the right side of the center line C, i.e., the side remote from the electric drive unit MDU in the width direction of the vehicle body 14. Thus, a larger overall space is created on the side closer to the drive unit MDU, as compared to a large diameter portion 20a of the axle housing 20 that houses the final speed reducer 22, thereby providing an advantage allowing the electric drive unit MDU and the transmission shaft 44 to be located in that space.

The final speed reducer 22 includes a speed reduction mechanism 50 and a differential gear mechanism 52 that are located inside the axle housing 20. The differential gear mechanism 52 includes a pair of side gears 54, 56 which are connected to the pair of drive shafts 26 and which are located inside the axle housing 20. The differential casing 60 is provided to be rotatable about a rotation axis C2 about which the side gears 54, 56 are rotatable. The differential casing 60 houses the pair of side gears 54, 56 and a pair of pinions 58 that mesh with the side gears 54, 56. The pinions 58 are rotatably supported by the differential casing 60.

The speed reduction mechanism 50 includes a pair of cylindrical gears consisting of a large-diameter gear 62 and a small-diameter gear 64. The large-diameter gear 62 is an output side gear, and is fixed to the differential casing 60. The small-diameter gear 64 is an input side gear, and has a diameter smaller than the large-diameter gear 62. The small-diameter gear 64 is disposed on a rotation axis C3 parallel to the rotation axis C2 about which the pair of side gears 54, 56 are rotatable. The axle housing 20 has a tubular shape, and includes a large diameter portion 20a serving as a casing storing the final speed reducer 22 and small diameter portions 20b storing the drive shafts 26. The large diameter portion 20a has a diameter larger than the small diameter portions 20b, and stores the speed reduction mechanism 50 and the differential gear mechanism 52. At least a largest diameter part of the large diameter portion 20a is located on the right side of the center line CL, namely, on the side remote from the electric drive unit MDU in the width direction of the vehicle body 14, i.e., in the right-left direction in FIG. 1. At least the largest diameter part of the large diameter portion 20a is located in a position that does not overlaps with the electric drive unit MDU in the longitudinal direction of the vehicle body 14. In the large diameter portion 20a, a lubricating oil F is stored for lubricating the speed reduction mechanism 50 and the differential gear mechanism 52. This lubricating oil F has a lower viscosity than a hypoid-gear oil used that is used where the large-diameter gear 62 and the small-diameter gear 64 are hypoid gears.

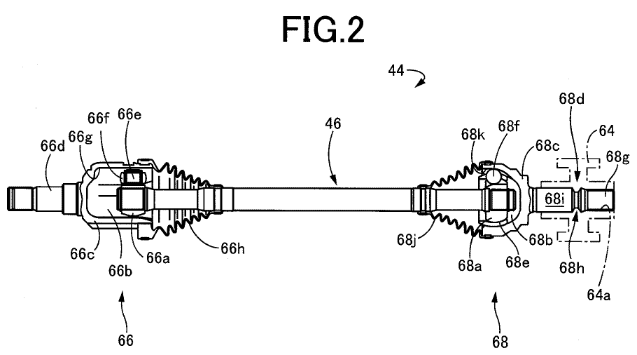

As shown in detail in FIG. 2, the transmission shaft 44 includes an intermediate shaft 46, which is made of, for example, mechanical structural carbon steel. The intermediate shaft 46 is connected, at an end portion on a side of the vehicle body 14, to the output shaft 42c of the speed reducer 42 that is a component located above suspension springs, through a vehicle-body-side constant-velocity joint 66. The intermediate shaft 46 is connected, at another end portion on a side of the axle housing 20, to the small-diameter gear 64 of the speed reduction mechanism 50 that is a component located below suspension springs, through an axle-housing-side constant-velocity joint 68. The vehicle-body-side constant-velocity joint 66 and the axle-housing-side constant-velocity joint 68 correspond to “first joint” and “second joint” recited in the appended claims, respectively. At least one of the vehicle-body-side constant-velocity joint 66 and the axle-housing-side constant-velocity joint 68, preferably the vehicle-body-side constant-velocity joint 66, is constituted by a sliding-type constant-velocity joint that is extendable and contractable in its axial direction. The vehicle-body-side constant-velocity joint 66 may be constituted by, for example, a sliding-type tripod constant-velocity joint, while the axle-housing-side constant-velocity joint 68 may be constituted by, for example, a Birfield-type constant-velocity joint or a Rzeppa-type constant-velocity joint.

The vehicle-body-side constant-velocity joint 66, which is constituted by, for example, the sliding-type tripod constant-velocity joint, includes a first inner race 66a that is fitted on the above-described end portion (on the side of the vehicle body 14) of the intermediate shaft 46, and a first outer race 66c that has a storing room 66b defined therein. The first inner race 66a is stored in the storing room 66b of the first outer race 66c. The vehicle-body-side constant-velocity joint 66 further includes a first connection shaft 66d which axially extends from the first outer race 66c and which is in spline-engagement with the output shaft 42c of the speed reducer 42, such that the first connection shaft 66d and the output shaft 42c are unrotatable relative to each other.

The first inner race 66a is provided with three radial shafts 66e extending radially outwardly and supporting respective three rollers 66f. The three rollers 66 f are received in respective three guide grooves 66g provided in an inner circumferential surface of the first outer race 66c and extending in the axial direction. Thus, the first outer race 66c is allowed to make an arcuate movement within a predetermined range, around the above-described end portion of the intermediate shaft 46 as a pivot point. An opening between the end portion of the intermediate shaft 46 and the first outer race 66c is covered by a bellows-type boot 66h made of a flexible resin material. The boot 66h has a conical shape, such that a large-diameter end portion of the boot 66h is fitted on the first outer race 66c, while a small-diameter end portion is fitted on the end portion of the intermediate shaft 46. A lubricating grease is filled inside the boot 66h.

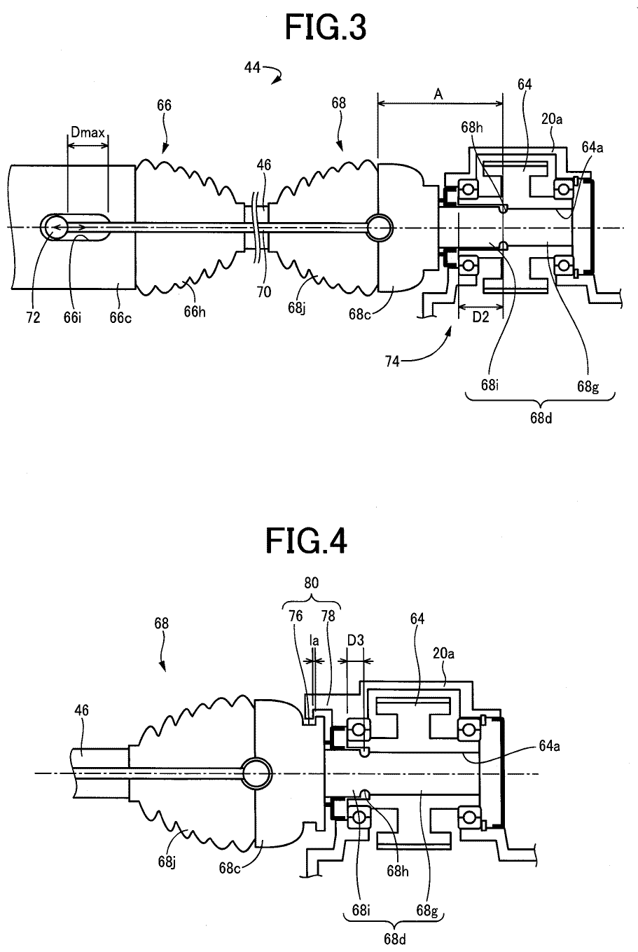

The axle-housing-side constant-velocity joint 68, which is constituted by, for example, the Birfield-type constant-velocity joint, includes a second inner race 68a that is fitted on the above-described other end portion (on the side of the axle housing 20) of the intermediate shaft 46, unrotatably relative to the intermediate shaft 46, and a cup-shaped second outer race 68c that has a storing room 68b defined therein. The second inner race 68a is stored in the storing room 68b of the second outer race 68c. The axle-housing-side constant-velocity joint 68 further includes a second connection shaft 68d which axially extends from the second outer race 68c and which is fitted in a fitting hole 64a provided in the small-diameter gear 64 of the speed reduction mechanism 50, such that the second connection shaft 68d and the small-diameter gear 64 are unrotatable relative to each other. The second connection shaft 68d is provided with a most vulnerable portion 68h having a strength smaller than any other portion of the transmission shaft 44. In the present embodiment, the most vulnerable portion 68h is constituted by a V-shaped annular groove provided in an outer circumferential surface of the second connection shaft 68d, as shown in FIG. 3. The second connection shaft 68d includes a fitting portion 68g that is located on a distal-end side of the most vulnerable portion 68h, such that spline teeth are provided in an outer circumferential surface of the fitting portion 68g. The fitting portion 68g corresponds to “connected portion” recited in the appended claims. The spline teeth of the outer circumferential surface of the fitting portion 68g of the second connection shaft 68d are in spline engagement with spline teeth provided in an inner circumferential surface of the fitting hole 64a of the small-diameter gear 64 of the speed reduction mechanism 50, so that the second connection shaft 68d and the small-diameter gear 64 are unrotatable relative to each other. It is noted that a non-fitting portion 68i of the second connection shaft 68d, which is located between the most vulnerable portion 68h and the second outer race 68c, is not provided with the spline teeth. The non-fitting portion 68i corresponds to “intermediate-shaft-side portion” recited in the appended claims. It is also noted that the small-diameter gear 64 of the speed reduction mechanism 50 has a through-hole through which the second connection shaft 68d is inserted, such that the above-described fitting hole 64a is a part of the through-hole, and such that another part of the through-hole constitutes a non-fitting hole in which the above-described non-fitting portion 68i of the second connection shaft 68d is located, and such that a radial clearance is provided between the non-fitting hole and the non-fitting portion 68i.

Between the second inner race 68a and the second outer race 68c, a hemispherical cage 68e and a plurality of balls 68f are provided such that the balls 68f are held within a plurality of retaining holes provided in the cage 68e. Each of an outer circumferential surface of the second inner race 68a and an inner circumferential surface of the second outer race 68c are provided with a plurality of guide grooves 68k extending in the axial direction, such that the balls 68f held within the retaining holes of the cage 68e are fitted and guided in the guide grooves 68k. Thus, the second outer race 68c and the small-diameter gear 64 of the speed reduction mechanism 50 are allowed to make an arcuate movement within a predetermined range, around the above-described other end portion of the intermediate shaft 46 as a pivot point.

An opening between the other end portion of the intermediate shaft 46 and the second outer race 68c is covered by a bellows-type boot 68j made of a synthetic rubber of a flexible resin material. The boot 68j has a conical shape, such that a large-diameter end portion of the boot 68j is fitted on an opening end portion of the second outer race 68c, while a small-diameter end portion is fitted on the other end portion of the intermediate shaft 46. A lubricating grease is filled inside the boot 68j.

FIG. 3 is a view schematically showing a construction of the most vulnerable portion 68h of the transmission shaft 44 shown in FIG. 2 and a construction of a separation prevention device 74. Owing to the vehicle-body-side constant-velocity joint 66 that is constituted by the sliding-type tripod constant-velocity joint, the transmission shaft 44 is allowed to be axially displaced by a distance that is not larger than a maximum slide distance Dmax. A slide member 72 is connected to the second outer race 68c through a rod 70, and is guided within an elongated hole 66i provided in the first outer race 66c. The above-described maximum slide distance Dmax is defined by a maximum distance by which the slide member 72 is allowed to be displaced within the elongated hole 66i. The maximum slide distance Dmax corresponds to “maximum displaceable distance” recited in the appended claims. It is noted that the most vulnerable portion 68h may be provided to extend within a range A, as seen in FIG. 3, which is from the opening end portion of the second outer race 68 c to the fitting portion 68g that is provided with the spline teeth.

As shown in FIG. 3, the non-fitting portion 68i of the second connection shaft 68d, which is located between the most vulnerable portion 68h and the second outer race 68c, is prevented, by the separation prevention device 74, from being removed or separated from the final speed reducer 22, irrespective of axial displacement of the transmission shaft 44 by the maximum slide distance Dmax. In the present embodiment, the separation prevention device 74 is constituted by the second connection shaft 68d in which an axial length D2 of an introduced part of the non-fitting portion 68i is not smaller than the above-described maximum slide distance Dmax, wherein the introduced part is a part of the non-fitting portion 68i which is introduced in the above-described non-fitting hole of the small-diameter gear 64. Owing to the separation prevention device 74, in event of breakage of the most vulnerable portion 68h, the non-fitting portion 68i, which is located between the most vulnerable portion 68h and the second outer race 68c, is prevented from being removed from the non-fitting hole of the small-diameter gear 64, namely, from being separated from the small-diameter gear 64.

In the drive apparatus 12 for the electric vehicle 10 according to the present embodiment, the transmission shaft 44 includes the intermediate shaft 46, the vehicle-body-side constant-velocity joint (first joint) 66 connecting between the intermediate shaft 46 and the electric drive unit MDU and the axle-housing-side constant-velocity joint (second joint) 68 connecting between the intermediate shaft 46 and the final speed reducer 22. The vehicle-body-side constant-velocity joint 66 includes the first outer race 66c and the first connection shaft 66d which extends from the first outer race 66c and which is connected to the electric drive unit MDU. The axle-housing-side constant-velocity joint 68 includes the second outer race 68c and the second connection shaft 68d which extends from the second outer race 68c and which is connected to the final speed reducer 22. The transmission shaft 44 includes the most vulnerable portion 68h having the strength smaller than any other portion of the transmission shaft 44, such that the most vulnerable portion 68h is located between the second outer race 68c and the fitting portion 68g at which the second connection shaft 68 d is connected to the final speed reducer 22. Thus, in case that a high load is applied to the transmission shaft 44, the most vulnerable portion 68h, which is located between the second outer race 68c and the fitting portion 68g (at which the second connection shaft 68d is connected to the final speed reducer 22) and which has the strength smaller than any other portion of the transmission shaft 44, would be broken first, thereby preventing damage to the intermediate shaft 46 exposed below a floor of the electric vehicle 10. Thus, it is possible to prevent a secondary damage to other components surrounding the intermediate shaft 46, which could occur if the intermediate shaft 46 suffers from run-out rotation during running of the electric vehicle 10.

In the drive apparatus 12 for the electric vehicle 10 according to the present embodiment, the separation prevention device 74 is configured, in event of breakage of the most vulnerable portion 68h, to prevent the non-fitting portion 68i of the second connection shaft 68d from being separated from the final speed reducer 22, irrespective of an axial displacement of the transmission shaft 44 by the maximum slide distance Dmax, wherein the non-fitting portion 68i of the second connection shaft 68d is located between the most vulnerable portion 68h and the second outer race 68c. Owing to the separation prevention device 74, in event of breakage of the most vulnerable portion 68h, the non-fitting portion 68i of the second connection shaft 68d can be prevented from being separated from the final speed reducer 22.

In the drive apparatus 12 for the electric vehicle 10 according to the present embodiment, the final speed reducer 22 includes: the differential gear mechanism 52 configured to distribute the power to the right and left drive wheels 18 through the respective drive shafts 26; and the speed reduction mechanism 50 consisting of the large-diameter gear 62 rotatable about the rotation axis C2 of the differential gear mechanism 52 and the small-diameter gear 64 rotatable about the rotation axis C3 parallel to the rotation axis C2. The second connection shaft 68d includes the fitting portion 68g which is located on the distal-end side of the most vulnerable portion 68h and which is fitted in the fitting hole 64a of the small-diameter gear 64 of the speed reduction mechanism 50. The fitting portion 68g has, in its outer circumferential surface, the external spline teeth that is held in engagement with the internal spline teeth provided in an inner circumferential surface of the fitting hole 64a of the small-diameter gear 64, such that the second connection shaft 68d and the small-diameter gear 64 are unrotatable relative to each other. The separation prevention device 74 is constituted by the second connection shaft 68d in which the axial length D2 of the introduced part of the non-fitting portion 68i is not smaller than the above-described maximum slide distance Dmax, wherein the introduced part is the part of the non-fitting portion 68i which is introduced in the above-described non-fitting hole of the small-diameter gear 64. Owing to the separation prevention device 74, in event of breakage of the most vulnerable portion 68h, the non-fitting portion 68i, which is located between the most vulnerable portion 68h and the second outer race 68c, is prevented from being removed from the non-fitting hole of the small-diameter gear 64, namely, from being separated from the small-diameter gear 64.

There will be described other embodiments of the present invention. The same reference signs as used in the above-described first embodiment will be used in the following embodiments, to identify the functionally corresponding elements, and descriptions thereof are not provided.

### Second Embodiment

In this second embodiment, as shown in FIG. 4, a separation prevention device 80 includes an annular groove 76 provided in an outer circumferential surface of the second outer race 68c and an engagement protrusion 78 protruding from the large diameter portion 20a of the axle housing 20 and held in engagement with the annular groove 76. An axial clearance la between the annular groove 76 and the engagement protrusion 78 is made smaller than an axial length D3 of an introduced part of the non-fitting portion 68i, wherein the introduced part is a part of the non-fitting portion 68i which is introduced in a non-fitting hole of the small-diameter gear 64, and wherein the non-fitting hole is a part of the through-hole of the small-diameter gear 64, which is other than the fitting hole 64a. The axial clearance la corresponds to “maximum displaceable distance” recited in the appended claims. Owing to the separation prevention device 80, in event of breakage of the most vulnerable portion 68h, the non-fitting portion 68i, which is located between the most vulnerable portion 68h and the second outer race 68c, is prevented from being removed from the non-fitting hole of the small-diameter gear 64, namely, from being separated from the small-diameter gear 64.

### Third Embodiment

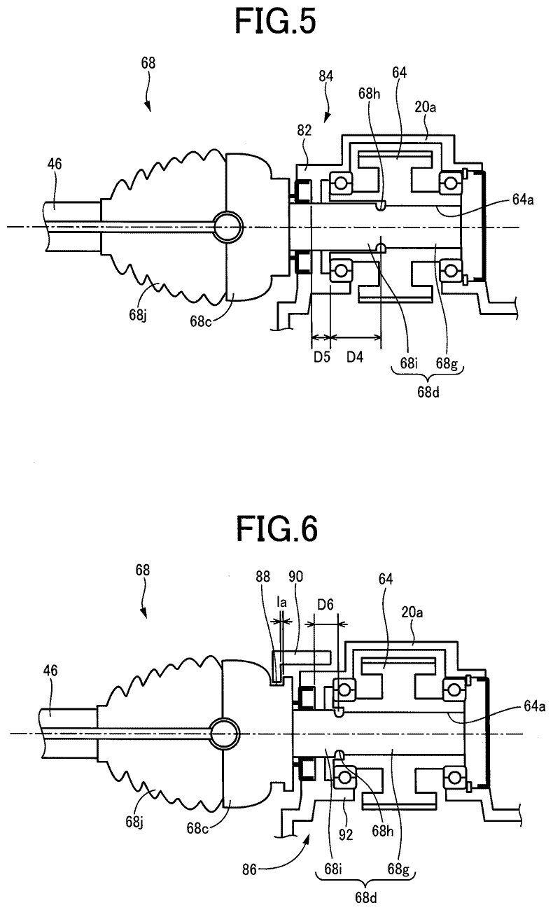

In this third embodiment, as shown in FIG. 5, a separation prevention device 84 includes a support protrusion 82 which extends from the large diameter portion 20a of the axle housing 20 and which is capable of supporting a protrusion portion of the second connection shaft 68d protruding out from the non-fitting hole of the second connection shaft 68d. The above-described maximum slide distance Dmax, which is a maximum distance by which the transmission shaft 44 is allowed to be displaced, is not larger than a sum of an axial length D4 and an axial length D5. The axial length D4 is an axial length of an introduced part of the non-fitting portion 68i, wherein the introduced part is a part of the non-fitting portion 68i which is introduced in a non-fitting hole of the small-diameter gear 64, and wherein the non-fitting hole is a part of the through-hole of the small-diameter gear 64, which is other than the fitting hole 64a. The axial length D5 is an axial length of a supported part of the non-fitting portion 68i, wherein the supported part of the non-fitting portion 68i is a part of the non-fitting portion 68i which is supported by the support protrusion 82. Owing to the separation prevention device 84, in event of breakage of the most vulnerable portion 68h, the non-fitting portion 68i, which is located between the most vulnerable portion 68h and the second outer race 68c, is prevented from being removed from the non-fitting hole of the small-diameter gear 64, namely, from being separated from the small-diameter gear 64.

### Fourth Embodiment

In this fourth embodiment, as shown in FIG. 6, a separation prevention device 86 includes an annular groove 88 provided in an outer circumferential surface of the second outer race 68c, an engagement protrusion 90 protruding from the large diameter portion 20a of the axle housing 20 and held in engagement with the annular groove 88, and a support protrusion 92 which extends from the large diameter portion 20a of the axle housing 20 and which is capable of supporting a protrusion portion of the second connection shaft 68d protruding out from the fitting hole 64a of the second connection shaft 68d, wherein the protrusion portion includes the non-fitting portion 68i and the most vulnerable portion 68h. The above-described axial clearance la between the annular groove 88 and the engagement protrusion 90 is made smaller than an axial length D6 of a supported part of the protrusion portion of the second connection shaft 68d, wherein the supported part a part of the protrusion portion which is supported by the support protrusion 92. Owing to the separation prevention device 86, in event of breakage of the most vulnerable portion 68h, the non-fitting portion 68i, which is located between the most vulnerable portion 68h and the second outer race 68c, is prevented from being separated from the small-diameter gear 64.

While the preferred embodiments of the invention have been described in detail by reference to the drawings, it is to be understood that the invention may be otherwise embodied.

For example, in the above-described embodiments, the electric vehicle 10, which is to be driven by a drive power source in the form of the electric motor 43, may be an electric vehicle (BEV vehicle) in which the drive wheels 18 as rear wheels are to be driven by the electric motor 43 as the single drive power source using an electric power stored in a battery, a four-wheel drive vehicle in which front wheels also serve as other drive wheels that are to be driven by another electric motor, or a series driving vehicle in which the electric motor 43 is to be driven by an electric power generated by an internal combustion engine. Further, the vehicle may be a four-wheel drive HEV (hybrid electric vehicle) in which front wheels are to be driven by an internal combustion engine and first and second electric motors that are connected through a power distribution mechanism, or by the internal combustion engine and the first electric motor that are connected through a clutch, while rear wheels are to be driven by the drive apparatus 12 shown in FIG. 1. Alternatively, the vehicle may be an engine vehicle that uses only an engine as its drive power source.

In the above-described embodiments, the suspension device 13 is constituted by the coil springs 30. However, the suspension device 13 may be constituted by leaf springs in place of the coil springs 30. In this case, the right and left upper trailing arm 32, right and left lower trailing arms 34 and lateral rod 36 are not provided, and the stabilizer bar link 38 is used, as needed, to limit tilting of the vehicle body 14.

It is to be understood that the embodiments described above are given for illustrative purpose only, and that the present invention may be embodied with various modifications and improvements which may occur to those skilled in the art.

### NOMENCLATURE OF ELEMENTS

10: electric vehicle
12: drive apparatus
14: vehicle body
18: drive wheels
20: axle housing
22: final speed reducer
30: coil spring (suspension spring)
44: transmission shaft
46: intermediate shaft
66: vehicle-body-side constant-velocity joint (first joint)
66c: first outer race
66d: first connection shaft
68: axle-housing-side constant-velocity joint (second joint)
68c: second outer race
68d: second connection shaft
68g: fitting portion (connected portion)
68h: most vulnerable portion
68i: non-fitting portion (intermediate-shaft-side portion)
74; 80; 84; 86: separation prevention device
MDU: electric drive unit
Dmax: maximum slide distance (maximum displaceable distance)
la: axial clearance (maximum displaceable distance)

What is claimed is:

1. A drive apparatus for a vehicle that includes a vehicle body and drive wheels, the drive apparatus comprising:
(a) a drive unit provided in the vehicle body;
(b) a final speed reducer configured to distribute a power of the drive unit, to the drive wheels;
(c) an axle housing which houses the final speed reducer and which supports the vehicle body through suspension springs; and
(d) a transmission shaft through which the power of the drive unit is to be transmitted to the final speed reducer,
wherein the transmission shaft includes (d-1) an intermediate shaft, (d-2) a first joint connecting between the intermediate shaft and the drive unit and (d-3) a second joint connecting between the intermediate shaft and the final speed reducer,
wherein the first joint includes (d-2-1) a first outer race and (d-2-2) a first connection shaft which extends from the first outer race and which is connected to the drive unit,
wherein the second joint includes (d-3-1) a second outer race and (d-3-2) a second connection shaft which extends from the second outer race and which is connected to the final speed reducer, and
wherein the transmission shaft includes a most vulnerable portion having a strength smaller than any other portion of the transmission shaft, such that the most vulnerable portion is located between the second outer race and a connected portion at which the second connection shaft is connected to the final speed reducer.

2. The drive apparatus according to claim 1, further comprising a separation prevention device configured, in event of breakage of the most vulnerable portion, to prevent an intermediate-shaft-side portion of the second connection shaft from being separated from the final speed reducer, irrespective of an axial displacement of the transmission shaft by a maximum displaceable distance,
wherein the intermediate-shaft-side portion of the second connection shaft is located between the most vulnerable portion and the second outer race.

3. The drive apparatus according to claim 1,
wherein the most vulnerable portion is constituted by a groove provided in an outer circumferential surface of the second connection shaft.
